(19) United States
(12) Patent Application Publication
(10) Pub. No.: US 2017/0346863 A1
(43) Pub. Date: Nov. 30, 2017

(54) Monitoring Network Events

(71) Applicant: Microsoft Technology Licensing, LLC, Redmond, WA (US)

(72) Inventors: Jason Thomas Faulkner, Seattle, WA (US); Mark Robert Swift, Mercer Island, WA (US); Alistair Robert Kilpatrick, London (GB); Kevin D. Morrison, Arlington, MA (US); Casey James Baker, Seattle, WA (US); Thomas Steven Bouchard, Seattle, WA (US)

(73) Assignee: Microsoft Technology Licensing, LLC, Redmond, WA (US)

(21) Appl. No.: 15/167,624

(22) Filed: May 27, 2016

(51) Int. Cl. H04L 29/06; H04N 7/14

(52) U.S. Cl. CPC H04L 65/4015; H04N 7/141

(57) ABSTRACT

A method of monitoring shared user event at a user terminal, including identifying one or more shared user events of which the user of the terminal is not a participant and obtaining information about the content and/or participants of said shared user event without becoming a participant of the shared user event. Based on said obtained information a display is caused to render at least one portal object representing said shared experience, the portal object providing a view of the content and/or participants of said shared experience.

### TECHNICAL FIELD

The present disclosure relates to communication and collaboration over a network, and to shared user events such as video or voice calls over a network.

### BACKGROUND

Communication and collaboration are key aspects in people's lives, both socially and in business. Communication and collaboration tools have been developed with the aim of connecting people to share experiences. In many or most cases, the aim of these tools is to provide, over a network, an experience which mirrors real life interaction between individuals and groups of people. Interaction is typically provided by audio and/or visual elements.

Such tools include instant messaging, voice calls, video calls, group chat, shared desktop etc. Such tools can perform capture, manipulation, transmission and reproduction of audio and visual elements, and use various combinations of such elements in an attempt to provide a communication or collaboration environment which provides an intuitive and immersive user experience.

A user can access such tools at a user terminal which may be provided by a laptop or desktop computer, mobile phone, tablet, games console or system or other dedicated device for example. Such user terminal can be linked in a variety of possible network architectures, such as peer to peer architectures or client-server architectures or a hybrid, such as a centrally managed peer to peer architecture.

### SUMMARY

It would be desirable to create an intuitive and natural communication and collaboration environment over a network.

According to a first aspect there is provided a method of monitoring a shared user event at a user terminal, comprising identifying one or more shared experiences of which the user of the terminal is not a participant; obtaining information about the content and/or participants of said shared experience, without becoming a participant of the shared experience; and causing a display to render at least one portal object representing said shared experience, based on said obtained information, said portal object providing a view of the content and/or participants of said shared event.

In this way, a user is advantageously able to observe or experience the shared event to at least a limited degree, even though he or she is not a participant of that event. This may inform a user and provide information to allow him or her to make a decision, for example whether he or she wishes to join the event to become a participant.

In embodiments, a participant is defined by an administrator or administrative function of the event, preferably by a list or directory of all participants of the event. The participants of the list or directory may be populated by unique user IDs for a given tool or application, or by and ID of a terminal or device, such as a static IP address for example. Alternatively, a combination of a device ID and a user ID can be used. In such an embodiment, a user and/or device which is not included in the list or directory is not considered a participant. Participants may be described as being ‘inside’ an event and non-participants as being ‘outside’ of an event

A participant may be defined by functionality in embodiments. For example, a user may be considered a participant of a shared event if that user can be seen or registered by other users who are participants. Conversely, a user who is not a participant of an event cannot be viewed or identified directly from that event. Such an embodiment is useful for allowing a user to view into or observe an event discretely via the portal object, without disturbing participants of the event.

A further functionality which may define a participant is the ability to provide input into the event. Such input may include audio or video input to a call for example, or comments or manipulations of a shared document. In such an embodiment therefore, an observer experiencing a view via a portal who is not a participant has a completely passive experience. This is a function of not being a participant of the event, and is distinct from a muted participant for example, where muting may be discretionary under control of one or more of the participants.

In embodiments a shared user event is a collaborative media sharing event, preferably a multi user peer to peer real time data sharing event. Such an event is preferably shared by two or more or three of more participants. A shared user event may comprise a voice call, video call, videoconference, group chat, shared desktop, a presentation, live document collaboration, or a broadcast in embodiments.

A user typically has a unique user ID or alias for a communication or collaboration tool or application, such as an application providing video chat or voice call facilities. A user may be active or logged in on a given terminal or device, and the terminal or device together with the user ID or alias can be used to control network traffic relating to communication to and from that user.

Embodiments may provide different ways a user can identify or become aware of a shared event of which the user is not a participant. In one example, a participant in an event may send an invitation to a non-participant outside of the event. Another possibility is that a non-participant may be alerted to events based on a comparison of the contents and/or participants of the event, and known characteristics or attributes or preferences of the user. Preferences of one or more participants of an event, e.g., privacy settings, may also be used to determine whether a given non-participant is made aware of an event.

In embodiments, said portal object includes at least one of: video of a participant of the event, a still image of a participant of the event, a view of a document or object shared by participants of the event.

Information obtained about the content and/or participants of said shared experience may be dedicated data intended for use by non-participants of the event, or may be, or be derived from, data shared as part of the event. In embodiments, information obtained is a reduced information version of data shared as part of the event. Such information is typically obtained over a network. In one example scalable video is provided of the same content in different resolutions, to allow reduced resolution video included in a shared event to be available for portal object generation.

Where information obtained includes video data, such video data may be degraded, cropped, or reduced in resolution to reduce its information content. Processing to reduce the information content is preferably performed before such information is transmitted to the non-participant. In this way, bandwidth usage is reduced, and hence network load/traffic can be similarly reduced. Furthermore, security can be enhanced, or permissions or access rights observed where degrading is used to conceal certain information by distorting, blurring or redacting for example. Additionally, or alternatively, processing may be performed after obtaining the information, and before using it to render said portal object.

In embodiments, the portal object displayed on the device provides a human-machine interface or interaction, to allow a user to view information about a multi-user event of which the user is not a participant, and to provide input in response. The provided input may control the amount and/or type of information viewed, and to control certain device settings, such as a camera, and ultimately to provide a control input to become a participant of the event, if desired.

In one example, a detected input associated with said portal object from the user, causes said portal object to be modified in response to said input to increase the amount of information provided by said view of the content and/or participants of said shared user event. Detecting said input may also or alternatively activate audio and/or video capabilities of the user terminal to capture audio and/or video data of a user.

In examples where the user input to the portal object is a variable input having a degree of variation, the amount of information provided by said view can be made dependent on the degree of the input. Such variable input may be movement on a touchscreen for example, and the amount of information provided by said view is dependent on the amount of movement, such as the extent of a drag or swipe movement.

Detecting input associated with said portal object from the user, may cause the user to join said shared user event to become a participant in response to said input in embodiments. An input to join the event may occur after inputs have resulted in other actions noted above, or a dedicated input to join the event may bypass other actions and cause the user to join the event substantially immediately. For example, a dedicated activation object may be provided together with the portal object, such as a “join now” button. This may be advantageous in allowing a user to join an event quickly and easily, without having to enter any further information or provide further input.

Methods described above may be computer implemented, and according to a further aspect there is provided a non-transitory computer readable medium or computer program product comprising computer readable instructions which when run on a computer including a display, cause that computer to perform a method substantially as described herein.

A yet further aspect of the invention provides a communication system including a plurality of user terminals, said communication system including a first user terminal connected to at least one second user terminal as part of a multi user event, said first and second terminals being participants of said event, and a third user terminal, which is not a participant of said event, including a display; wherein said third terminal is adapted to obtain information about the content and/or participants of said event from at least one of said first and second terminals, without becoming a participant of the event; and to provide on said display at least one portal object representing said shared experience, based on said obtained information, said portal object providing a view of the content and/or participants of said shared experience.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 illustrates schematically an example communications system;

FIG. 2 is a functional schematic of a user terminal;

FIG. 3 shows a display for a communication and collaboration environment;

FIG. 4 shows a display for a communication visualisation;

FIG. 5 is an example or a portal object;

FIG. 6 shows possible display positions of a portal object;

FIGS. 7a to 7d show configurations of a portal object on a mobile user terminal;

FIG. 8 is a flow diagram showing a method of monitoring a shared user event.

### DETAILED DESCRIPTION OF EMBODIMENTS

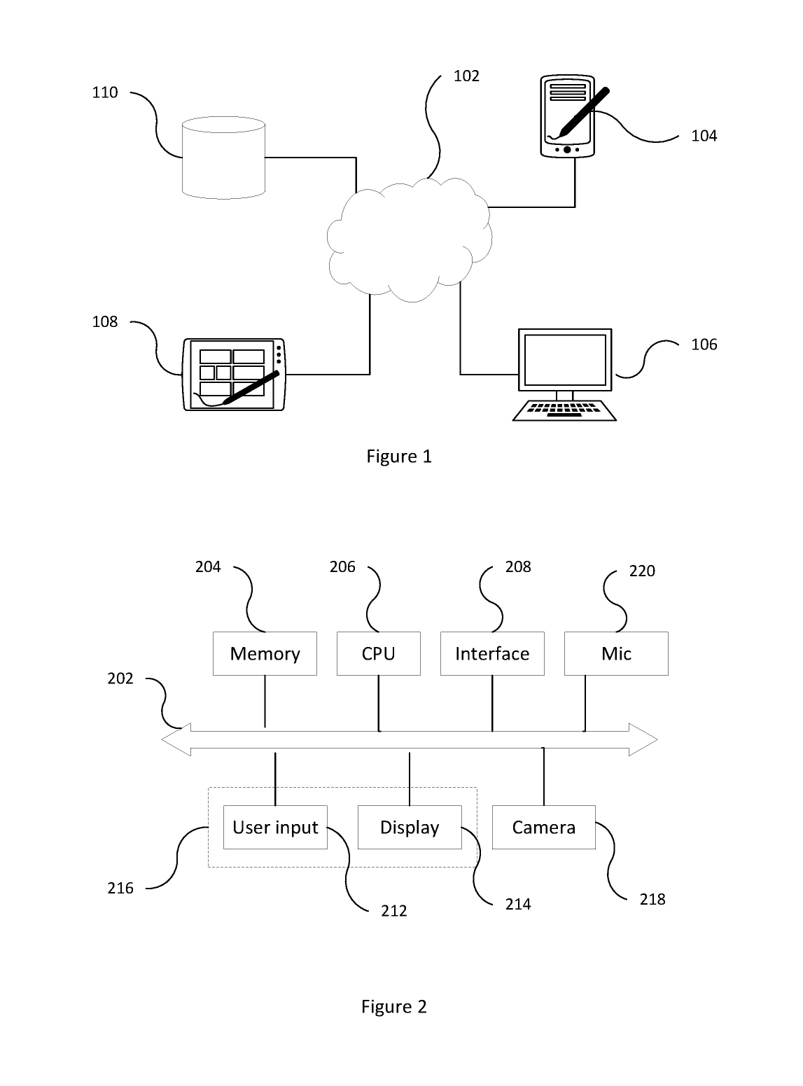

FIG. 1 illustrates an example of a communication system including example terminals and devices. A network 102 such as the internet or a mobile cellular network enables communication and data exchange between devices 104-110 which are connected to the network via wired or wireless connection. A wide variety of device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216. Programs such as communication or collaboration applications stored memory 204 for example can be executed by the CPU, and can cause an object to be rendered and output on the display 214. A user can interact with a displayed object, providing an input or inputs to module 212, which may be in the form of clicking or hovering over an object with a mouse for example, or tapping or swiping or otherwise interacting with the control device using a finger or fingers on a touchscreen. Such inputs can be recognized and processed by the CPU, to provide actions or outputs in response. Visual feedback may also be provided to the user, by updating an object or objects provided on the display 214, responsive to the user input(s). Optionally a camera 218 and a microphone 220 are also connected to the bus, for providing audio and video or still image data, typically of the user of the terminal.

User terminals such as that described with reference to FIG. 2 may be adapted to send audio and/or visual data, over a network such as that illustrated in FIG. 1 using a variety of communications protocols/codecs, optionally in substantially real time. For example, audio may be streamed over a network using Real-time Transport Protocol, RTP (RFC 1889), which is an example of an end to end protocol for streaming media. Control data associated with media data may be formatted using Real time Transport Control Protocol, RTCP (RFC 3550). Sessions between different apparatuses and/or user terminals may be set up using a protocol such as Session Initiation Protocol, SIP.

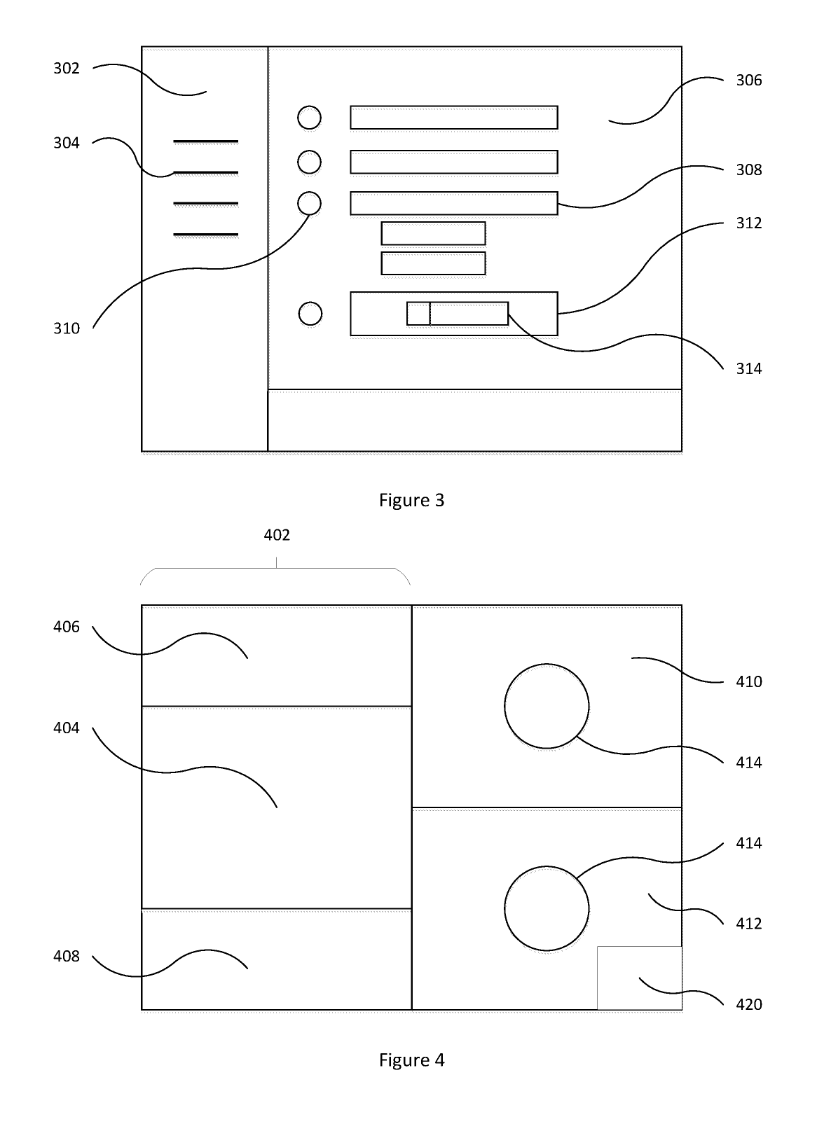

A display as illustrated in FIG. 3 can be provided to a user as part of a communication application, providing a communication environment or visualisation. A user having a unique ID may have a number of contacts within a communication application environment, and may for example belong to a number of groups. A group or groups can define a channel comprising a number of members or groups of members sharing content. The display as illustrated in FIG. 3 can be provided to members of such a channel. Such a display is typically suited to a user terminal such as a laptop or desktop computer, or possibly a tablet device.

A side bar or area 302 can be used to provide information of other users of the tool or application with whom it is possible to communicate or collaborate. Users can be displayed individually, and/or groups of users and/or channels can be displayed, as illustrated by lines 304, and a user can select between them.

A main area 306 shows messages and chat threads occurring within a selected channel.

A message or post 308 contains text content, and an object or icon 310 shows an identifier of a user making the post, which icon can be a picture or avatar or other graphic device. A post 312 contains an embedded link 314, representing a file such as a document for example.

Users of such a communication and collaboration tool are able to engage in shared user events, such as an audio or video call for example. Such a user event is typically defined by one or more participants, with data being shared between participants, typically in real time. Typically, a list of participants, which may be a list of user IDs (possibly also in combination with a device address or an IP address) is defined, and such a list is used to control transmission of data representing the content of the event between participants. Participants of an event may comprise individual users, each accessing the event via separate devices. Participants may also be multiple users grouped at a terminal or device.

A shared user event may be instigated by specifying one or more users as participants. A shared user event is typically initiated by and administrator or organizer who invites one or more other users to participate in the event. This may be performed by using commands in the sidebar 302, for example double clicking or tapping a user name or a group name, and providing respective commands or inputs to set parameters for the event.

A shared user event may be live, and data provided by participants or participant's terminals, such as text, voice, video, gestures, annotations etc. can be transmitted to the other participants substantially in real time. A shared user event may however be asynchronous. That is, data or content provided by a user may be transmitted to other participants at a later time.

FIG. 4 illustrates a display provided to a participant of a shared user event, in this case a video/audio call.

It can be seen that a display or screen is divided up into different areas or grid sections, each grid section representing a participant of the call. Here the grid is shown with rectangular cells which are adjacent, but the grid cells may be other shapes such as hexagonal or circular for example, and need not be regular or adjacent or contiguous. On the left hand side of the screen, area 402 is assigned to a participant, and a video stream provided by that user is displayed in area 404 It can be seen that area 404 does not fill the whole grid section 402. In order to preserve its aspect ratio, the video is maximised for width, and background portions 406 and 408 exist above and below the video.

The right hand side of the display is dived into two further rectangular grid sections.

Each of these grid sections includes an identifier 414 to identify the participant or participants attributed to or represented by that grid section. The identifier may be a photo, avatar, graphic or other identifier, surrounded by a background area 410 for the upper right grid section as viewed, comprising substantially the rest of grid section. In this case, the grid sections on the right hand side represent voice call participants, and these participants each provide an audio stream to the shared event.

A self view 420 is optionally provided in the lower right corner of the display to allow a user to view an image or video of themselves which is being, or is to be sent to other users, potentially as part of a shared even such as a video call. The self view 420 sits on top of part of the background 412 of the lower right hand grid section

Within an event, that is amongst the participants of an event, a hierarchy and/or permissions can be established. Considering permissions, one participant may act as an administrator or presenter, and have permission control affecting the functionality of other participants in the event. Such functionality includes the ability to share graphical content, such as a presentation, or to mute or unmute other participants. Other permissions include permission to receive audio and/or video from all or selected participants. Thus participants may have varying levels of functionality within the shared event.

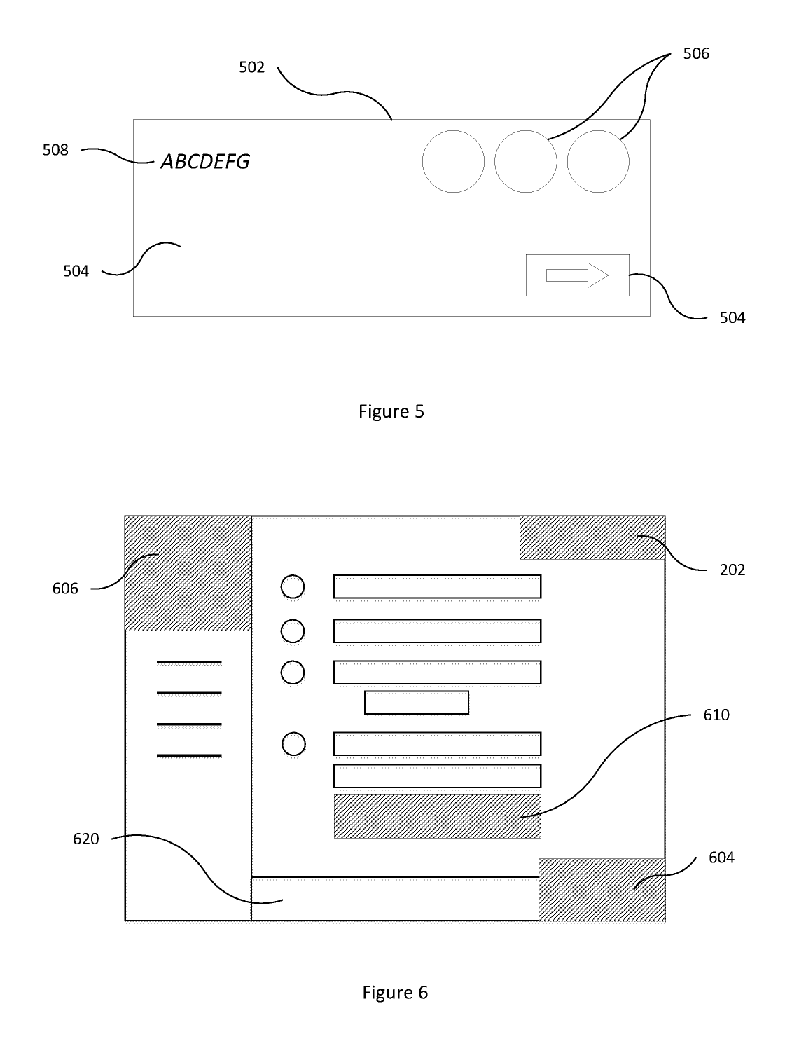

An example of a portal object is shown in FIG. 5.

The portal object 502 has a background area 504 on which is superposed details including icons or objects 506 that represent and identify participants of the event. If too many participants are present, only a limited number can be displayed, and the number of further participants can be indicated in a single icon. For example, “+3” in a circle would indicate three further participants to those already indicated.

Text 508 can be used to indicate the name of the organizer or administrator of the event, and one or more activation objects 510 can be provided together with the portal object to allow a user to provide an input to perform a specific task relating to the event which the portal represents. For example, an activation object can be provided to allow a user to provide an input to become a participant of the event, or initiate processing to become a participant of the event. Advantageously, such an activation object can allow a user to become an event participant with a single input such as a click or tap.

Background area 504 can be used to provide an indication or visualisation of the content of the event to which the portal object relates. In the example where the shared event is a video call, content may for example include multiple video and audio streams corresponding to multiple different participants. Background area 504 may therefore display one or more of such video streams.

In examples such as that shown in FIG. 6, the portal object typically only occupies a small portion of display real estate, allowing other display activities to take place simultaneously. Therefore, where video is displayed in the background of the portal object, such video is typically scaled or reduced. Reduction may be by way of resolution, or by cropping for example. Other possible types of manipulation to produce video for a portal view include changing aspect ratio and fish-eye distortion for example. Thus in such an example it can be seen that the portal object provides a scaled version of a grid view as illustrated in 4, for non-participants of the event. If multiple video streams are included in the shared event, one of said streams may be selected to be displayed in the portal object. This may be the video stream associated with the organiser or administrator of the event, or it may be determined based on a level of activity, to reflect the most active participant.

Using the background area 504 for video from the event is one example, but depending on the type of event, and available content, other possibilities include shared media or documents from the event, such as a spreadsheet or presentation or broadcast for example.

Display in the background area 504 of the portal object is based on information obtained about the contents of the shared event. Full information of, say, a video stream or shared document may be obtained, and this information can be processed in order to be in a suitable form for creating the portal object. Such processing typically reduces the information content, to allow display in a smaller area than originally intended or in native resolution. For example, downsampling may be employed. Other possible processing may assist in may include fish eye distortion Reducing the information content may also be in the form or redaction, or blurring or distortion, where it is desired to reduce the information provided by the portal in specific aspects. This may be in order to observe permissions or access rights to information about the event.

In examples, only a subset of the information of the content of the event is obtained.

This may be all that is available to a non-participant of the event, with such a sub-set being specifically made available for the purposes of a portal object. In such a case, one or more participants may control the content made available, and may provide different content to different non-participants, based on user settings, profiles and preferences for example.

In one example scalable video is provided, of the same content in different resolutions, to allow reduced resolution video included in a shared event to be available for portal object generation.

As noted, the portal object typically only occupies a small area of a display, allowing the remainder of the display to function as usual, such as in FIGS. 3 and 4 for example. The portal object may be provided in a number of configurations or positions as shown in FIG. 6.

FIG. 6 shows a display for monitoring a channel, similar to that shown in FIG. 3 for example. A first position for a portal object is in a corner of the display such as the top right 602 or bottom right 604 of the display. In this position the portal object is rendered in front of other display objects which might otherwise be viewed. For example, portal object 604 is rendered on top of a menu bar 620.

The portal object may be ‘docked’ in a dedicated position or display area in the underlying display so than no other display information is occluded. For example, the top portion of a side bar as indicated at 606 may be used to display the portal object. A further option in a display of a channel where a number of posts are provided, is for the portal object to be displayed in the manner of a post as indicated at 610.

The portal object can be displayed over or as part of a variety of possible display screens, which may, but need not, belong to a communication or collaboration application. In one example, the portal object is displayed in a calendar, preferably at the corresponding time and or date. The portal object can be scaled and configured to fit the underlying display in which it appears.

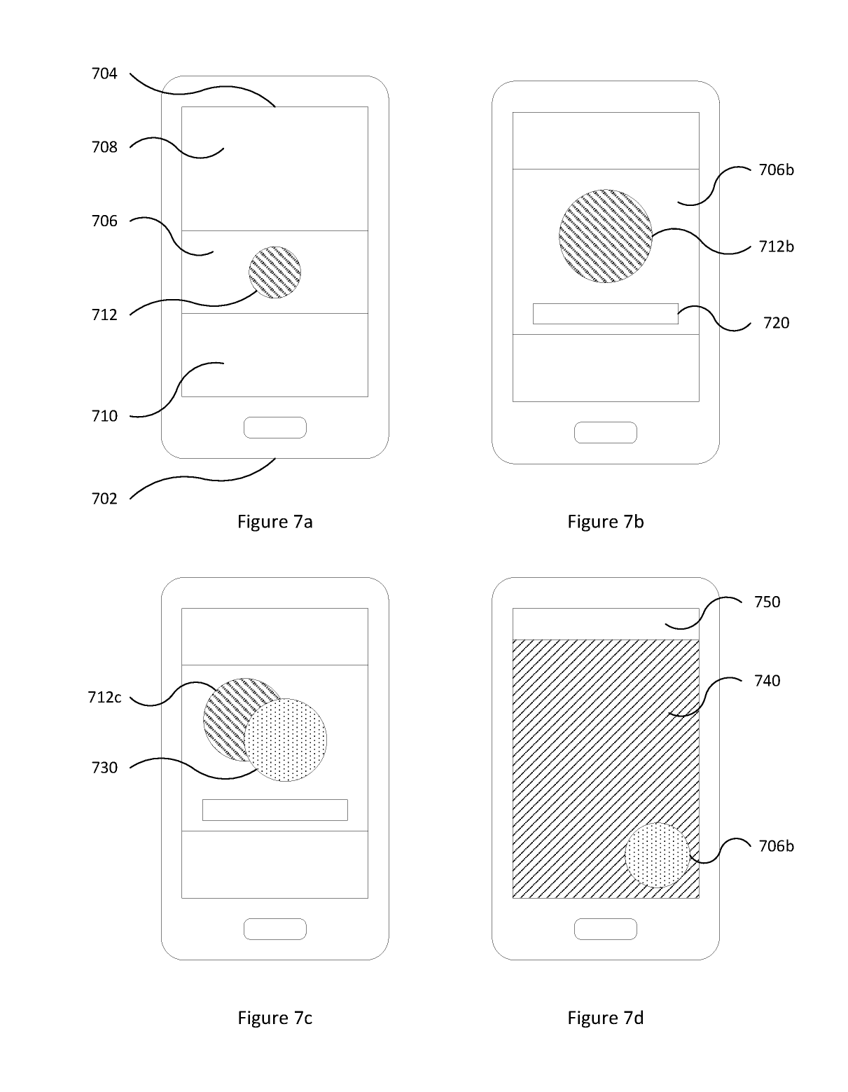

FIG. 7a shows a portal object 706 rendered on the display 704 of a mobile device such as a smart phone or tablet 702. The portal object 706 is substantially rectangular and located in the centre of the display, leaving upper 708 and lower 710 portions of the display unobstructed. A window object 712 is provided in the portal object, and used to display content information of the event to which the portal relates. Window object 712 may be used to provide an indication or visualisation of the content of the event to which the portal object relates, in an analogous way to background 504 of the portal object described in relation to FIG. 5, and description thereof will not be repeated here. Such indication or visualisation can therefore, for example, include video streams and/or shared media or documents from the event, and is indicated by diagonal shading. Further information (not shown) of content and/or participants of the event may be provided in portal object 706

A user may provide an input to or associated with portal object 706. In the example of a smart phone or tablet, a tap or swipe of a finger on a touch screen can be detected on or over the portal object. In response to such input, the portal object is updated as shown in FIG. 7b. It can be seen that portal object 706b has been increased in size vertically to occupy a greater portion of the overall display area. Window object 712b has also increased in size, allowing a larger view of the content displayed in that window, relating to the relevant shared user event. Text or other graphic information indicated as 720 is also generated, providing further information about the event.

Thus the user input to the portal object has increased the amount of information about the shared user event which can be viewed. By providing further information the user is able to make a more informed decision whether or not to join and become a participant of the event. In the example of a user using a swipe input to a touchscreen, a variable input is provided (swiping a greater or lesser distance in this example), and the increase in information, and optionally size of the portal can be controlled in response to the degree of variation of the input. Therefore, by swiping more, the amount of information viewable is increased.

In FIG. 7c, continuing input by the user to the portal object, for example by continuing to swipe further as discussed above, cause a self-view window 730 to be displayed in the portal object 706c. Window object 712c is partially offset and partially obscured by self-view window 730. Self-view window 730 displays video of the user from a user facing camera of the device 702, which is activated in response to the input to the portal object. His stage acts as a preparation phase before becoming a participant in a multi user event. It allows a user to preview the video stream which will be shared with other participants upon entering the event.

Further input from the state shown in FIG. 7c, such as by continuing to swipe, or optionally another input which can be detected, such as a double tap for example, causes the user to become a participant of the event, and device 702 transitions to the state shown in FIG. 7d displaying live video, indicated by diagonal shading 740 in a full grid view, occupying most of the display area. The grid view may comprise a single grid section corresponding to a single participant video stream, or may comprise multiple grid sections in an analogous fashion to the view shown in FIG. 4. Self-view window 730c is provided to the lower right of the display, and a top bar 750 may be used to display participant information of the event for example.

Thus In the examples described above, the portal object displayed on the device provides a human-machine interface or interaction, to allow a user to view information about a multi-user event of which the user is not a participant, and to control the amount and/or type of information viewed, and to control certain device settings, such as a camera, and ultimately to provide a control input to become a participant of the event, if desired.

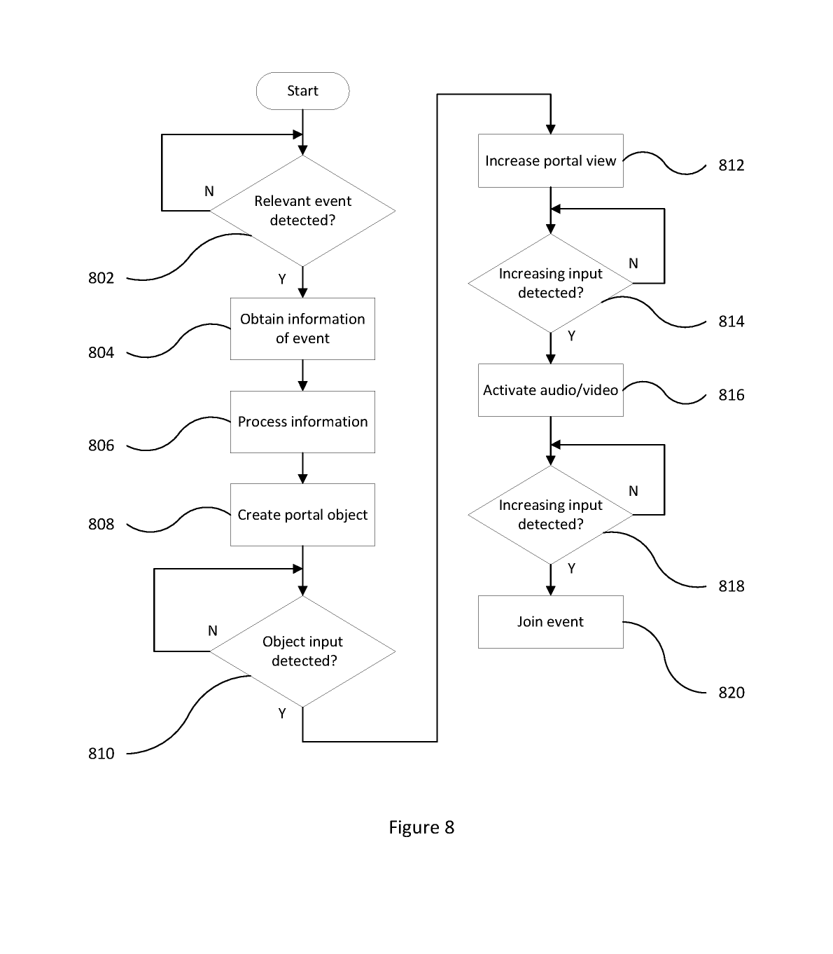

FIG. 8 is a flow diagram illustrating a method of monitoring a shared user event. After starting, at step 802 it is determined whether a relevant event is detected.

A user can be made aware of an event of which he or she is a non-participant based on shared characteristics or attributes of the user and such events. For example, a user may have a contacts list or belong to certain groups of users for example. In a business environment, groups may be set up corresponding to departments such as marketing or finance, while in a social context, a group may correspond to a football team, or a book group for example.

A relevant event may be detected if at least one of the participants in that event is in a group of which the non-participant user is also a member. A threshold may be set so that more than a given number of participants in a common group must exist, before the non-participant is alerted, or that the common member or members of a group must be an administrator or organizer of an event, for example. The content of the event can also be referenced against known characteristics or attributes of a non-participant user, for example by recognizing words or phrases in the title of extracted from audio or text exchanges within the event. In a business environment, the name of a project may be included in the title of a shared user event, and a non-participant user may be notified of the event based on that project name. A relevant event may also be detected if an invitation is issued from one or more participants of the event.

In some embodiments, participants, or at least an organizer or administrator of an event may have access to privacy settings, to control what aspect of the event, and to whom, information is provided. This can control who can detect an event, and if detected, to what extent the event can be viewed in a portal object.

In this way, a non-participant user can be intelligently informed of events which are considered to be relevant, based on preferences of the user and optionally preferences of the participants of the event.

If no relevant event is detected, the process returns and waits for a relevant event. If a relevant event is detected, the process advances to step 804, and information of the relevant event is obtained.

Dedicated information of the event may be provided for the purpose of portal monitoring, which information is separate, or different from the information exchanged as part of the event. Such data may be broadcast on a network to any interested parties, or transmitted to a specific party where it is desired to notify such parties of the event, e.g., in the example of an invitation to the event being sent. Alternatively, the information may be provided on receiving a request. The request will typically include the address or ID of the user requesting the information, and this can be referenced against permissions set in the event to determine if the information, or the extent of information, is to be sent in response to the request. Such information may include details of some or all of the participants of the event, and may include degraded, redacted, or reduced resolution content information.

Alternatively, if no dedicated information is provided for the purpose, information which is exchanged as part of the event may be provided, subject to checking permissions, in response to a request for information. Processing and/or logic for determining which information is provided (for example if there are multiple video streams and only one video stream is to be provided, or requested) may be provided at the non-participant user terminal, or by a terminal or server included in the event.

Once information is obtained, the process proceeds to step 806. This is an optional step for processing the obtained information, for example downsampling, resizing or cropping video.

Next, at step 808, a portal object is created for display on a display or screen of a user terminal. The portal object may be substantially as described with reference to 502 and 706 of FIGS. 5 and 7 above.

Once the portal object is created and displayed, it is determined at step 810 whether an input associated with the portal object is detected. The input can be a click or hover with a mouse pointer for example, or a tap or swipe with a finger on a touchscreen, on or over the portal object. The exact placement of the input may depend on the precise configuration of the portal object, which may include dedicated activation objects such as object 510 illustrated in FIG. 5. If an input is detected, and optionally if it is confirmed that it matches a predetermined input type, then the process advances to step 812, where the portal view is increased.

Increasing the portal view may correspond to increasing the amount of information displayed, increasing the size of the portal, or both. An example of increasing the portal view is shown in FIGS. 7a to 7c for example. It should be noted that steps 812 to 818 are optional in some embodiments, and input detected at step 810 can advance the process directly to step 820 described below.

At step 814 it is determined whether increasing user input is detected. Such increasing input could correspond to a user continuing to scroll or swipe in the case of a touchscreen input, or could be further clicking or double clicking in other instances. If such increasing input is detected, the process advances to step 816 where audio and/or video capabilities of a user terminal are activated. For example, a self camera can be turned on. In addition, a display object may be provided to display self video, and such object may be part of the portal object. If increasing input is not detected, the process returns to waiting for further input.

At step 818 it is determined if continued input associated with the portal object is detected, which may be the same as step 814, or may detect another type of input. If a positive determination results, the process advances to step 820. If a negative determination results, the process returns to wait for further input.

At step 820, the user is joined to the event, and becomes a full participant. In an alternative arrangement, the user sends a request to join the event, and becomes a participant only when the invitation is accepted by a current participant.

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure—including the processor 202—may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. The described processor 202 may also be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A method of monitoring shared user event at a user terminal, said method comprising:
identifying one or more shared user events of which the user of the terminal is not a participant;
obtaining information about the content and/or participants of said shared user event, without becoming a participant of the shared user event;
causing a display to render at least one portal object representing said shared experience, based on said obtained information, said portal object providing a view of the content and/or participants of said shared experience.

2. A method according to claim 1, further comprising detecting input associated with said portal object from the user, and modifying said portal object in response to said input to increase the amount of information provided by said view of the content and/or participants of said shared user event.

3. A method according to claim 1, further comprising detecting input associated with said portal object from the user, and activating, in response to said input, audio and/or video capabilities of the user terminal to capture audio and/or video data of a user.

4. A method according to claim 1, further comprising detecting input associated with said portal object from the user, and joining said shared user event to become a participant in response to said input.

5. A method according to claim 2, wherein said input is a variable input having a degree of variation, and wherein the amount of information provided by said view is dependent on the degree of the input.

6. A method according to claim 5, wherein said variable input is a movement on a touchscreen, and the amount of information provided by said view is dependent on the amount of movement.

7. A method according to claim 4, further comprising providing an activation object together with said portal object, and joining said shared user event directly to become a participant in response to detected input associated with said activation object.

8. A method according to claim 1, wherein said shared user event is one of a video and/or audio call, a presentation, live document collaboration, or a broadcast.

9. A method according to claim 1, wherein said shared user event includes a video component and said portal object includes a representation of said video component.

10. A method according to claim 9, wherein said representation is a degraded, cropped or reduced resolution version of said video component.

11. A method according to claim 1, wherein said portal object includes at least one of: video of a participant of the event, a still image of a participant of the event, a view of a document or object shared by participants of the event.

12. A non-transitory computer readable medium comprising computer readable instructions which when run on a computer including a display, cause that computer to perform operations including:
identifying one or more shared user events of which the user of the terminal is not a participant;
obtaining information about the content and/or participants of said shared user event, without becoming a participant of the shared user event;
causing a display to render at least one portal object representing said shared experience, based on said obtained information, said portal object providing a view of the content and/or participants of said shared experience.

13. A communication system including a plurality of user terminals, said system including:
a first user terminal in communication with at least one second user terminal as part of a multi user event, said first and second terminals being participants of said event, and
a third terminal, which is not a participant of said event, including a display;
wherein said third terminal is adapted to obtain information about the content and/or participants of said event from at least one of said first and second terminals, without becoming a participant of the event; and
to provide on said display at least one portal object representing said shared experience, based on said obtained information, said portal object providing a view of the content and/or participants of said shared experience.

14. A communication system according to claim 13, wherein said multi user event includes a video component and said portal object includes a representation of said video component.

15. A communication system according to claim 14, wherein said representation is a degraded, cropped or reduced resolution version of said video component.

16. A communication system according to claim 13 wherein said portal object includes a representation of the number of participants in said event.

17. A communication system according to claim 13, wherein said multi user event is one of a video and/or audio call, a presentation, live document collaboration, or a broadcast

18. A communication system according to claim 13, wherein said multi user event is a live event.
